(19) United States
(12) Patent Application Publication
(10) Pub. No.: US 2004/0261123 A1
(43) Pub. Date: Dec. 23, 2004

(54) Method and apparatus for decoding transport streams including video and audio data

(76) Inventors: Kazuya Yamada, Tokyo (JP); Terumasa Kuramoto, Tokyo (JP); Daisuke Yamauchi, Tokyo (JP); Yasuo Masuda, Sagamihara-shi (JP); Mutsumi Yamamoto, Tokyo (JP)

Correspondence Address: CLARK & BRODY, 1750 K STREET NW, SUITE 600, WASHINGTON, DC, 20006, US

(21) Appl. No.: 10/863,488

(22) Filed: Jun. 9, 2004

(30) Foreign Application Priority Data
Jun. 17, 2003 (JP) 2003-171542

(51) Int. Cl. H04N 7/173; G06F 13/00; H04N 5/445; G06F 3/00

(52) U.S. Cl. 725/131; 725/151; 725/135; 375/240.01

(57) ABSTRACT

A decoding apparatus is provided for decoding transport streams in which compressed video and audio data, a program association table (PAT), and program map tables (PMTs) are multiplexed. The apparatus comprises a specification unit, a search unit, and decoding circuits. The specification unit allows a user to specify a service ID and program IDs corresponding to user's desired video and audio data. The search unit searches service IDs described on the PAT and program IDs on the PMT for the service ID and the program IDs specified through the specification unit. Determinations for consistency are made between the service ID described on the PAT and the user's desired service ID and between the program IDs on the PMT and the user's desired program IDs. The decoding circuits decode compressed video and audio data corresponding to the service ID and the program IDs searched by the search unit.

### BACKGROUND OF THE INVENTION

1. Technical Field

The present invention relates to a method and apparatus for decoding video and audio data, and in particular, to a method and apparatus for transport streams including compressed and multiplexed video and audio data.

2. Related Art

New styles of television digital broadcasting, such as satellite digital broadcasting and ground-based digital broadcasting, have now been spotlighted. The television digital broadcast uses a plurality of carrier waves of which frequencies are different from each other, which correspond to the conventional television channels.

Each of the plural carrier waves transmits a plurality of multiplexed packets each including video and audio data. In the digital broadcast, one carrier wave has a plurality of sets of video and audio signals covering multiple angle video signals and multiple language audio signals. To view a desired program through the digital broadcast, it is thus required to select one of the plural videos and audios.

In addition, the digital broadcast employs the MPEG (Moving Picture coding Experts Group)-2, so that video data, audio data and other necessary data are carried in the form of TSs (Transport Streams) in an MPEG-2 system. In the MPEG-2 system, video data, audio data and other necessary data are coded based on the rules such as MPEG-2 video and audio coding, respectively, and packetized and converted into PESs (Packetized Elementary Streams) before being multiplexed.

Concurrently, information necessary for each receiver to separate and decode those multiplexed data is multiplexed into TS signals in the form of tables such as PAT (Program Association Table) and PMT (Program Map Table). For identification, PIDs (Program IDs) are assigned to streams composed of video and audio data, PATs, PMTs and others. In each PAT are described both service IDs and PIDs of corresponding PMTs to the service IDs. Furthermore, in each PMT, PIDs of video and audio streams included in each service ID are described.

Upon receiving such a TS signal, an MPEG decoder first finds out a PAT to read the descriptions therein. Then the MPEG decoder finds out a PMT directed to a service ID specified in the descriptions in the PAT, reads out a PID of video and audio from the found-out PMT, and decodes a stream of the PID.

A technique for replaying through selection of a PID in a digital broadcast with a plurality of programs is disclosed by Japanese Patent Laid-open publication No. 2001-94942. In this publication, a user first selects a signal of a desired carrier frequency and specifies a program (i.e., a service ID). A receiver will respond to this operation to select a PID having a minimum number among corresponding PMTs and to extract corresponding video packets and audio packets for decoding.

However, if it is found out, after starting the replay of the program (i.e., video and audio), that the program is not desired one for the user, the following procedures will be taken.

In such a situation, the receiver once decodes the video and audio data of the smallest number. The user is then requested to advance to the next step to open a selection menu window for the programs. The user then chooses a user's desired video and audio program from the menu. Responsively the receiver uses an identified PID to extract the packets of the chosen video and audio for decoding.

However, for replaying a user's desired video and audio in this way, it is required for the user to open a selection menu window to select the desired program. This means that, even when the user already knows the PID number of a desired program, the video and audio of the program can finally be decoded after the user follows an irritating, time consuming process where the chosen video is finally able to play.

### SUMMARY OF THE INVENTION

The present invention has been made with due consideration to the foregoing difficulty, and an object of the present invention is to provide a decoding apparatus capable of immediately starting to replay desired video and audio data, with eliminating the necessity that a user is requested to perform the operations of displaying a menu window to specify desired video and audio items on the displayed menu.

To achieve the above object, the present invention provides, as one aspect, a decoding apparatus for decoding transport streams in which compressed video data, compressed audio data, a program association table (PAT), and program map tables (PMTs) are multiplexed, a program ID being assigned to each of the video data and the audio data, a service ID being described on the program association table, and program IDs being described on the program map tables. The decoding apparatus comprises a specification unit, a determination unit, and decoding circuits. The specification unit is configured to allow a user to directly specify both of a service ID and program IDs corresponding to the user's desired video data and audio data. The determination unit is configured to acquire the program association table from the transport streams, determine whether or not the service ID described on the program association table is consistent with the service ID specified through the specification unit, when it is determined that the service ID described on the program association table is consistent with the specified service ID, acquire a program map table corresponding to the determined service ID, among the program map tables, from the transport streams, and determine whether or not the program IDs on the acquired program map table is consistent with the program IDs specified through the specification unit. The decoding circuit respectively decodes compressed video and audio data corresponding to the service ID and the program IDs determined by the determination unit.

As a result, a user (i.e., viewer) is allowed to directly input into the decoding apparatus a service ID and program IDs corresponding to the user's desired video data and audio data. The determination unit responds to such a user's input by searching the PAT and PMTs for the service ID and program IDs corresponding to the user's desired video data and audio data. In this search, determinations for consistency are made between the service ID described on the PAT and the user's desired service ID and between the program IDs on the PMT and the user's desired program IDs. The decoding circuits are thus able to begin decoding the user's desired compressed video and compressed audio data corresponding to the user's specified service ID and program IDs through a simple processing procedure.

The decoding apparatus is thus able to immediately start replaying the desired video and audio data. This eliminates the necessity of a user being requested to perform the operations of displaying a menu window to specify a desired video and audio item on the displayed menu.

### BRIEF DESCRIPTION OF THE DRAWINGS

Other objects and aspects of the present invention will become apparent from the following description and embodiments with reference to the accompanying drawings in which:

FIG. 1 is an outlined configuration of a receiving system for digital satellite broadcast, which is according to a first embodiment of the present invention;

FIG. 2 is a block diagram showing the configurations of a receiver and an MPEG decoder both of which are incorporated in the receiving system of the first embodiment, the decoding apparatus according to the present invention being reduced into practice as the MPEG decoder;

FIG. 3 is a flowchart showing the processing for decoding transport streams, which is carried out by the MPEG decoder according to the first embodiment;

FIG. 4A pictorially illustrates a two-step determination conducted by the MPEG decoder for decoding the transport streams;

FIG. 4B shows a hierarchical structure of PATs, PMTs, video data and audio data;

FIG. 5 is a flowchart showing the processing for decoding transport streams, which is carried out by the MPEG decoder according to a second embodiment of the present invention; and

FIG. 6 is a flowchart showing the processing for decoding transport streams, which is carried out by the MPEG decoder according to a third embodiment of the present invention.

### DETAILED DESCRIPTION OF PREFERRED EMBODIMENTS

Referring to the accompanying drawings, preferred embodiments of the present invention will now be described.

[First Embodiment]

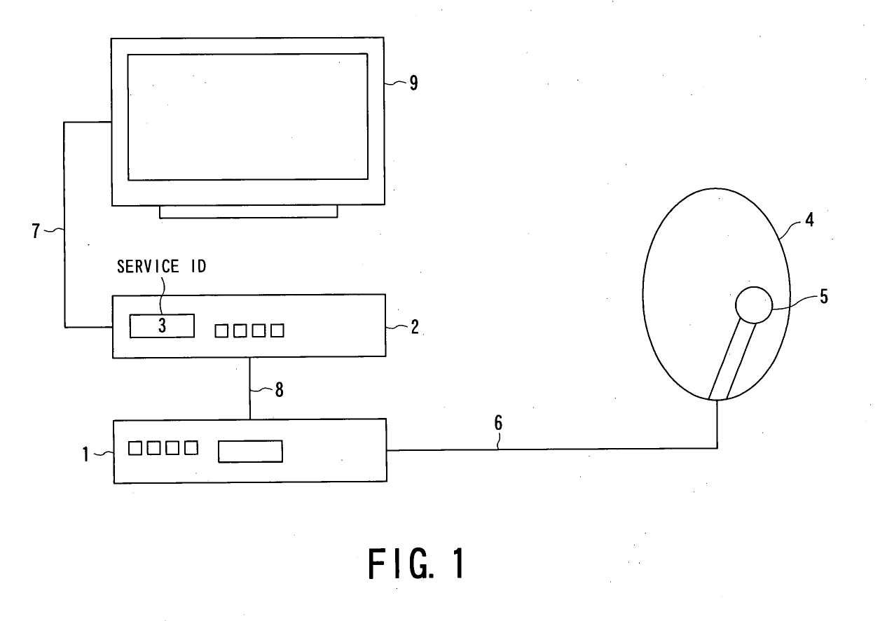

Referring to FIGS. 1 to 4, a first embodiment of the decoding apparatus according to the present invention will now be described.

FIG. 1 outlines a receiving system for digital satellite broadcast, the present invention being applied to this receiving system. As shown therein, the receiving system is provided with a receiver 1, an MPEG decoder 2, and a television receiver 9. The decoding apparatus according to the present invention is thus reduced into practice as the MPEG decoder 2 and the recording method according to the present invention is performed with the MPEG decoder 2.

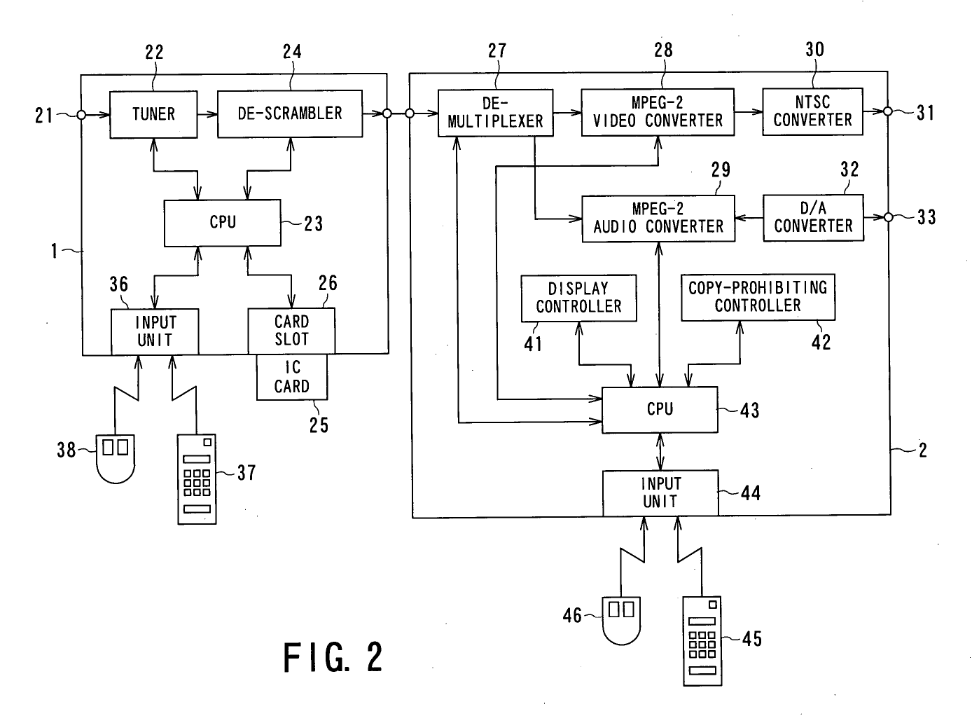

The receiver 1 has a digital output terminal (not shown), while the MPEG decoder 2 has a digital input terminal (not shown). The digital output and input terminals are connected to each other via a cable 8 to send data (i.e., demodulated transport streams, which will be described below) from the receiver 1 to the MPEG decoder 2. FIG. 2 illustrates in detail the entire configurations of both the receiver 1 and the MPEG decoder 2.

The receiver also has an antenna terminal, which is connected via a cable 6 to a low noise converter 5 attached on a parabolic antenna 4. Radio waves from satellites are transmitted, for example, in a band of 12 GHz. The radio waves from the satellites are received by the parabolic antenna 4, in which the received radio waves are converted into, for example, signals in a band of 1 GHz by the low noise converter 5. Such converted signals are fed via a cable 6 to the antenna terminal of the receiver 1. The receiver 1, which receives such converted signals resultant from the radio waves under the digital satellite broadcast, is in charge of demodulating the signals to produce transport streams (TSs).

The transport streams demodulated by the receiver 1 are fed via the cable 8 to the MPEG decoder 2, as stated above. The MPEG decoder 2 is equipped with video and audio output terminals connected through cables 7 to video and audio input terminals of the television receiver 9, respectively. Video and audio signals decoded by the MPEG decoder 2 are thus fed to the video and audio input terminals of the television receiver 9. Thus the television receiver 9 is able to provide videos of desired programs on the screen and to output audio sound.

Both the receiver 1 and the MPEG decoder 2 will now be more detailed in connection with FIG. 2.

As shown, the receiver 1 is equipped with a tuner 22 connected to an antenna terminal 21, a CPU 23, a de-scrambler 24, a card slot 26 into which an IC card 25 can be inserted, and an input unit 36 to which a remote control 37 and/or a mouse 38 are connected.

Signals inactive of radio waves, which are from the parabolic antenna 4, are supplied to the tuner 22 via the antenna terminal 21. The remote control 37 or mouse 38, which is operatively connected to the CPU 23 via the input unit 36, is used by a user to specify a desired carrier wave. Responsively to specifying a carrier wave with the remote control 37 or mouse 38, the CPU 23 operates to allow the tuner 22 to select a specified carrier wave signal and then to allow the de-scrambler 24 to descramble the carrier wave signal so that MPEG transport steams are demodulated. The demodulated transport streams are thus fed from the receiver 1 to the MPEG decoder 2.

On the other hand, the MPEG decoder 2 is equipped with a demultiplexer 27, an MPEG-2 video decoder 28, an MPEG-2 audio decoder 29, an NTSC converter 30, a video output terminal 31, a D/A converter 32, an audio output terminal 33, a display controller 41, a copy-prohibiting controller 42, a CPU, and an input unit 44 operatively linked with a remote control 45 and/or a mouse 46.

The transport steams, which have arrived at the MPEG decoder 2, are first given to the demultiplexer 27. When the remote control 45 or mouse 46 is used by a TV viewer (user) to specify, to the MPEG decoder 2, a service ID (for example, “3”), a video PID (for example, “0×100”), and an audio PID (for example, “0×200”), which are all desired to be replayed by the TV viewer, the demultiplexer 27 responds to this specification. That is, the demultiplexer 27 extracts, from the transport streams, video packets and audio packets corresponding to the PIDs (Program IDs) specified by the CPU 43. Selecting a program from the transport streams is based on a service ID, a video PID and an audio PID which have been inputted by a TV viewer in advance.

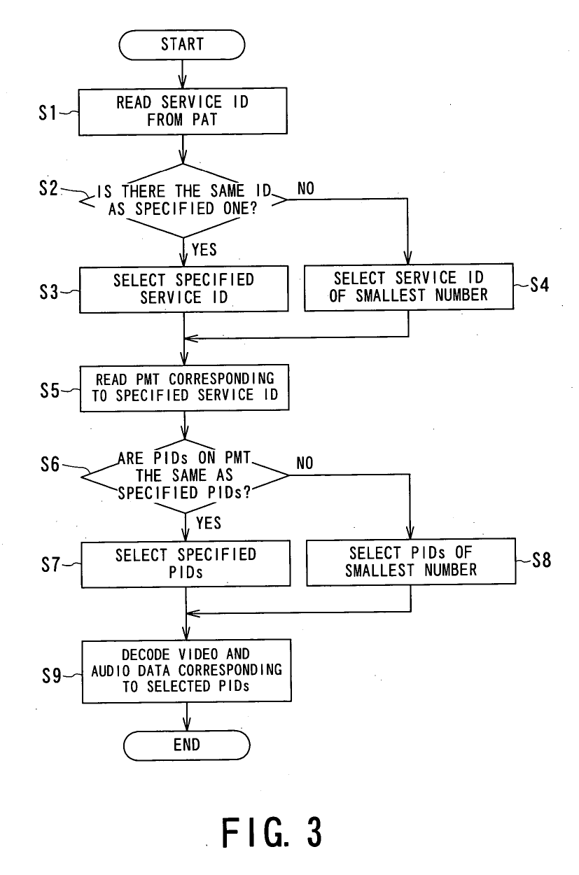

The operations of the MPEG decoder 2 will now be described with reference to FIG. 3. The flowchart shown in FIG. 3 is conducted by the CPU 43, in which data of a program for the sequences shown in FIG. 3 is previously installed. The CPU 43 operates based on the sequences defined by the program, in cooperation with the demultiplexer 27. Alternatively, the procedures shown in FIG. 3 may be given in advance, as a software program, to the demultiplexer 27, not the CPU 43.

First of all, the CPU 43 of the MPEG decoder 2 first searches for a PAT (Program Association Table). Since each PID on the PAT is assigned to “0×00,” so that the indexes consisting of PIDs “0×00” are used to search for the PAT and read a description thereof (FIG. 3, step S1).

It is then determined whether or not there is the same service ID as the specified service ID “3” among the service IDs described on the PAT (step S2). If the service ID “3” is found, the service ID “3” is selected (steps S2 to S3). In contrast, when it is determined that there is no service ID “3,” a service ID having the smallest number is selected (steps S2 and S4).

The service ID “3” which has been selected from the description on the PAT is then subjected to reading a PMT (Program Map Table) thereof (step S5). It is then determined whether or not a PMT-described PID corresponding to the service ID “3” is consistent with both of the video PID “0×100” and the audio PID “0×200,” which have been specified by the TV viewer (step S6). When it is determined that there is the consistency between both the PIDs, both of video data of the PID “0×100” and audio data of the PID “0×200” are selected (steps S6 to S7). By contrast, if there is no consistency between both the PIDs, a PID having the smallest number is selected (steps S6 and S8).

Thus both the video packets and the audio packets are acquired which correspond to the specified video and audio PIDs. The video packets are fed to the MPEG-2 video decoder 28, while the audio packets are fed to the MPEG-2 audio decoder 29, with those packets decoded thereat (step S9). Resultant decoded video signals are sent to the NTSC converter 30, where video signals on the NTSC rule are produced and outputted from the video output terminal 31. Concurrently with this, resultant decoded audio signals are sent to the D/A converter 32, where the signals are A/D-converted before being outputted through the audio output terminal 33.

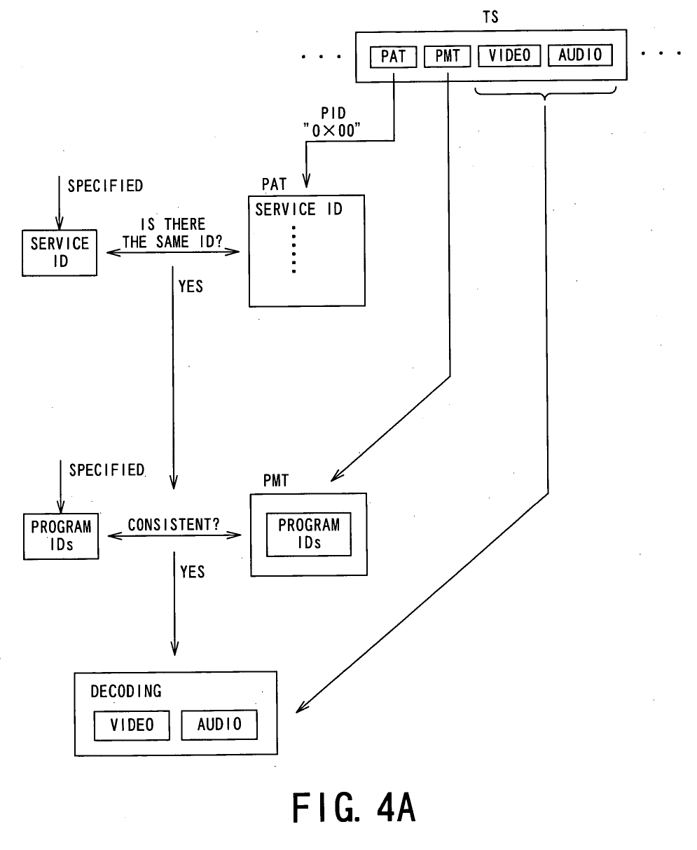

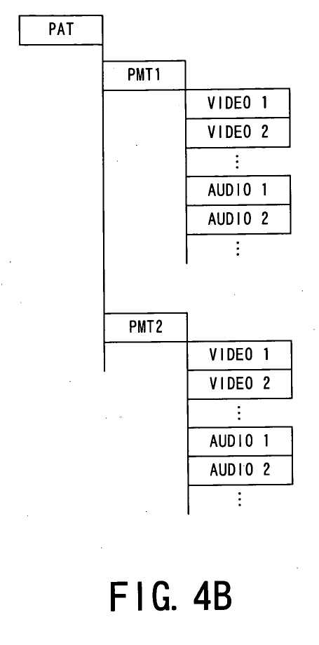

The processing involving the above two-stage comparison using both the service ID and the video and audio PIDs can be illustrated as in FIG. 4A. Actually, the TS in FIG. 4A is formed, as shown in FIG. 4B, into a hierarchical structure of PATs, PMTs, video data, and audio data.

In this way, the MPEG decoder 2 allows a TV viewer to directly specify a service ID and program IDs showing viewer's desired service and video and audio data. From a plurality of programs transmitted as transport streams, the MPEG decoder 2 selects streams responding to the viewer-specified service ID and video and audio PIDs, and decodes the video and audio data in the selected streams. The MPEG decoder 2 is therefore able to immediately replay the viewer's desired video and audio data, resulting in that there is no longer necessary for the viewer to manually display the menu window to specify viewer's desired video and audio thereon through viewer's manual operations. This remarkably simplifies the viewer's operations, provided that the viewer already knows his or her desired PIDs. In addition, viewer's waiting time for a desired program can also be considerably shortened.

[Second Embodiment]

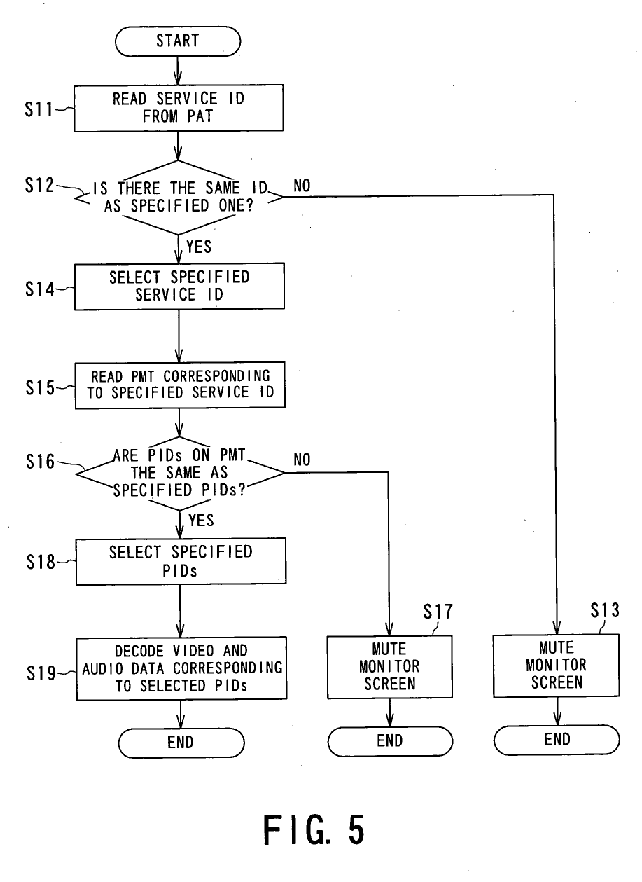

Referring to FIG. 5, a second embodiment of the decoder according to the present invention will now be described.

The second embodiment features another way of processing carried out when there is no consistency between a viewer's specified service ID and a read-out service ID and between viewer's specified PIDs and read-out PIDs.

In this second embodiment, the decoder according to the present invention is reduced into practice as the MPEG decoder 2 shown in FIG. 2, like the first embodiment. Consequently, the hardware configuration in the second embodiment is omitted from being explained. The same references as those used in the first embodiment are to be used in this second embodiment as well. This explanation manner is also applied to a third embodiment described later.

The MPEG decoder 2 performs the processing shown in FIG. 5. Practically, a PAT is first analyzed to acquire a service ID in a transport stream from information about the analyzed PAT (FIG. 5, step S11). It is then determined if or not the PAT information includes a service ID which is the same as a viewer's specified service ID (step S12).

If it is determined that there is not the same service ID, the CPU 43 commands the display control circuit 41 to issue a mute signal to be sent to the MPEG-2 video decoder 28 via the CPU 43. As a result, the mute signal allows video signals (the screen) to be muted (steps S12 to S13).

In contrast, if it is determined at step S12 that there is the same service ID, the service ID is selected (steps S12 and S14). Furthermore, a PMT corresponding to the selected service ID is subjected to analysis to obtain information about the PMT, from which a video PID and an audio PID relevant to the service ID is acquired (step S15).

It is then determined whether or not the video and audio PIDs described on the PMT are consistent with the PID specified by a TV viewer (step S16). When there is no consistency between the PIDs (NO at step S16), a muting command is issued from the display control circuit 41 under the control of the CPU 43, so that the screen is muted (steps S16 to S17).

Hence, in cases where there is no desired service ID or video and audio PIDs described on the PMT are different from a viewer's desired one, the video signals are muted in any event. In this case, the audio signals may also be muted together with the video signals.

Contrary to the above, when it is determined that there is a consistency between the PIDs (YES at step S16), video data whose PID is “0×100” and audio data whose PID is “0×200” are selected (steps S16 and S18). In this way, video packets and audio packets, both of which correspond to the viewer's specified PIDs, are acquired and decoded.

Accordingly, when there is no service ID consistent with a service ID specified by a viewer or the video and audio PIDs on the PMT differ from a service ID specified by a viewer, the video signals are muted to show such situations clearly, without selecting a service ID having the smallest number, unlike the processing in the first embodiment.

In addition to the advantages explained in the first embodiment, an additional advantage is therefore provided. Namely, muting the screen, as described above, is effective in giving the viewer a clear sign that the currently specified service ID or video and audio PIDs are not available, that is, a viewer's desired program cannot be replayed and those IDs should be changed to other ones.

[Third Embodiment]

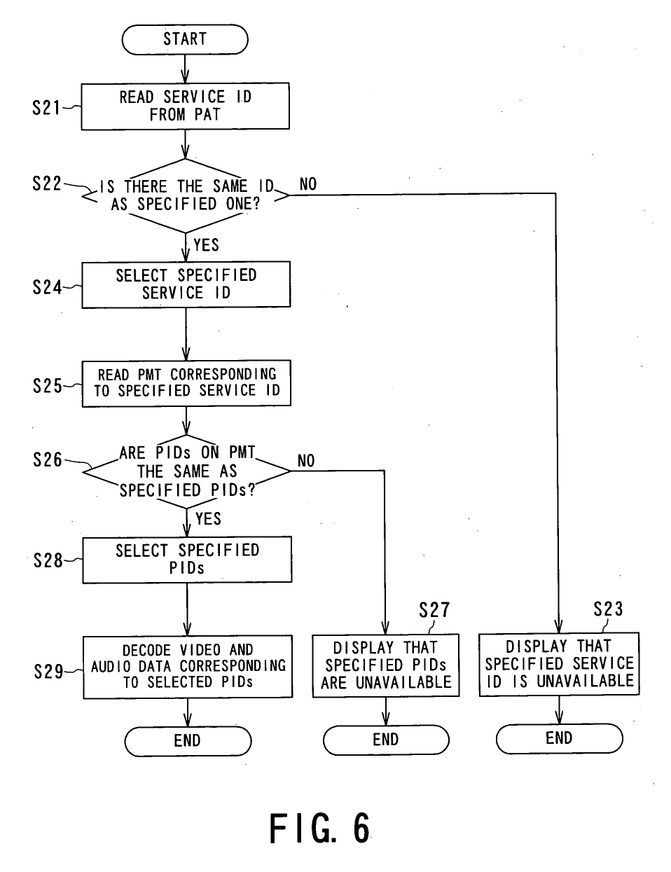

Referring to FIG. 6, a third embodiment of the decoder according to the present invention will now be described.

The third embodiment features another way of processing carried out when there is no consistency between a viewer's specified service ID and read-out service ID and between viewer's specified PIDs and read-out PIDs.

The MPEG decoder 2 performs the processing shown in FIG. 6. Practically, a PAT is first analyzed to acquire a service ID in a transport stream from information about the analyzed PAT (FIG. 6, step S21). It is then determined if or not the PAT information includes a service ID which is the same as a viewer's specified service ID (step S22).

If it is determined that there is not the same service ID, the CPU 43 commands the display control circuit 41 to issue a display signal to be sent to the MPEG-2 video decoder 28 via the CPU 43 (steps S22 to S23). The display signal shows a massage that “No service ID is found, so that the replay cannot be done.” This massage is displayed on the screen of the television receiver 9 in such a situation. Hence the massage that the service is unavailable can be given to the TV viewer.

In contrast, if it is determined at step S22 that there is the same service ID, the service ID is selected (steps S22 and S24). Furthermore, a PMT corresponding to the selected service ID is subjected to analysis to obtain information about the PMT, from which a video PID and an audio PID relevant to the service ID is acquired (step S25).

It is then determined whether or not the video and audio PIDs described on the PMT are consistent with the PID specified by the TV viewer (step S26). When there is no consistency between the PIDs (NO at step S26), the. CPU 43 causes the display control circuit 41 to issue a command indicating a message of, as above, “No service ID is found, so that the replay cannot be done” (steps S26 to S27).

Hence, in cases where there is no desired service ID or video and audio PIDs described on the PMT are different from a viewer's desired one, a warning massage window is displayed on the screen. In this case, the audio signals may be muted concurrently with the display of the warning massage.

In contrast, when it is determined that there is a consistency between the PIDs (YES at step S26), video data whose PID is “0×100” and audio data whose PID is “0×200” are selected (steps S26 and S28). In this way, video packets and audio packets, both of which correspond to the viewer's specified PIDs, are acquired and decoded.

Accordingly, when there is no service ID consistent with a service ID specified by a viewer or the video and audio PIDs on the PMT differ from a service ID specified by a TV viewer, the warning message appears on the screen of the television receiver 9, unlike the processing in the first embodiment.

In addition to the advantages explained in the first embodiment, there is provided, like the second embodiment, an additional advantage that this display is effective in giving the viewer a clear sign that the currently specified service ID or video and audio PIDs are not available.

By the way, in the second and third embodiments, the processing carried out when there are no matched service ID or PIDs can be modified into various other ways. That is, the processing is not limited to muting the monitor screen or displaying the message. Alternatively, in such a case where no matched service ID or PIDs are found, the MPEG decoder 2 may flash the monitor screen, change hues in the entire or a partial area on the monitor screen, generate an alarm sound, or take any other appropriate means solely or in a combined manner.

The present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description and all changes which come within the meaning and range of equivalency of the claims are therefore intended to be embraced therein.

The entire disclosure of Japanese Patent Application No. 2003-171542 filed on Jun. 17, 2003 including the specification, claims, drawings and summary is incorporated herein by reference in its entirety.

What is claimed is:

1. A decoding apparatus for decoding transport streams in which compressed video data, compressed audio data, a program association table (PAT), and program map tables (PMTs) are multiplexed, a program ID being assigned to each of the video data and the audio data, a service ID being described on the program association table, and program IDs being described on the program map tables, the decoding apparatus comprising:
a specification unit configured to allow a user to directly specify both of a service ID and program IDs corresponding to user's desired video data and audio data;
a determination unit configured to:
acquire the program association table form the transport streams,
determine whether or not the service ID described on the program association table is consistent with the service ID specified through the specification unit,
when it is determined that the service ID described on the program association table is consistent with the specified service ID, acquire a program map table corresponding to the determined service ID, among the program map tables, from the transport streams, and
determine whether or not the program IDs on the acquired program map table is consistent with the program IDs specified through the specification unit; and
decoding circuits respectively decoding compressed video and compressed audio data corresponding to the service ID and the program IDs determined by the determination unit.

2. A decoding apparatus for decoding transport streams in which compressed video data, compressed audio data, a program association table (PAT), and program map tables (PMTs) are multiplexed, a program ID being assigned to each of the video data and the audio data, a service ID being described on the program association table, and program IDs being described on the program map tables;
a specification unit configured to allow a user to directly specify both of a service ID and program IDs corresponding to user's desired video data and audio data;
a search unit configured to search both the service ID described on the program association table and the program ID on the program map table for both the service ID and the program IDs specified through the specification unit; and
decoding circuits respectively decoding compressed video and compressed audio data corresponding to the service ID and the program IDs searched by the search unit.

3. The decoding apparatus according to claim 2, wherein the search unit comprising
a first acquisition/determination unit configured to acquire the program association table form the transport streams and determine whether or not the service ID described on the program association table is consistent with the service ID specified through the specification unit; and
a second acquisition/determination unit configured to, when the first acquisition/determination unit determines that the service ID described on the program association table is consistent with the specified service ID, acquire a program map table corresponding to the determined service ID, among the program map tables, from the transport streams and determine whether or not the program IDs on the acquired program map table is consistent with the program IDs specified through the specification unit.

4. The decoding apparatus according to claim 3, comprising a control unit configured to perform notification means for notifying the user of a situation where at least one of the first and second acquisition/determination units makes a negative determination of being inconsistent.

5. The decoding apparatus according to claim 4, wherein the notification means is configured to issue a command to mute at least one of the video data and the audio data to be outputted to a display monitor.

6. The decoding apparatus according to claim 4, wherein the notification means is configured to issue a command to display a massage saying “unavailable” on a monitor screen.

7. A method for decoding transport streams in which compressed video data, compressed audio data, a program association table (PAT), and program map tables (PMTs) are multiplexed, a program ID being assigned to each of the video data and the audio data, a service ID being described on the program association table, and program IDs being described on the program map tables, the method comprising the steps of:
receiving a service ID and program IDs corresponding to user's desired video data and audio data;
acquiring the program association table form the transport streams;
first determining whether or not the service ID described on the program association table is consistent with the user's desired service ID;
when it is determined that the service ID described on the program association table is consistent with the user's desired service ID, acquire a program map table corresponding to the determined service ID, among the program map tables, from the transport streams;
second determining whether or not the program IDs on the acquired program map table is consistent with the user's desired program IDs; and
decoding compressed video and compressed audio data corresponding to the user's desired service ID and the user's desired program IDs, respectively, when a positive determination of being consistent is made in each of the first and second determining steps.
